(19) United States
(12) Patent Application Publication
(10) Pub. No.: US 2012/0077088 A1
(43) Pub. Date: Mar. 29, 2012

(54) METHOD FOR MANUFACTURING POSITIVE ELECTRODE ACTIVE MATERIAL FOR NONAQUEOUS ELECTROLYTE SECONDARY BATTERY, POSITIVE ELECTRODE ACTIVE MATERIAL, AND NONAQUEOUS ELECTROLYTE SECONDARY BATTERY BY USING THE SAME

(75) Inventors: Kazunori Donoue, Sumoto-shi (JP); Denis Yau Wai Yu, Singapore (SG)

(73) Assignee: SANYO ELECTRIC CO., LTD., Osaka (JP)

(21) Appl. No.: 13/245,370

(22) Filed: Sep. 26, 2011

(30) Foreign Application Priority Data
Sep. 24, 2010 (JP) 2010-214127

(51) Int. Cl. H01M 4/505; C01D 15/02; H01M 4/04

(52) U.S. Cl. 429/224; 252/182.1; 423/599

(57) ABSTRACT

A method for manufacturing a positive electrode active material for a nonaqueous electrolyte secondary battery including the steps of mixing a lithium source and a tetravalent manganese source and reacting the lithium source and the manganese source at a temperature lower than 600° C. while tetravalent manganese is reduced, so as to produce a lithium manganese compound oxide, wherein the positive electrode active material is formed from the lithium manganese compound oxide where the lithium manganese compound oxide is represented by a general formula LiₓMnO₂ (x≧1) and which has a crystal structure of a space group C2/m.

### CROSS REFERENCE TO RELATED APPLICATIONS

The present invention claims priority to Japanese Patent Application No. 2010-214127 filed in the Japan Patent Office on Sep. 24, 2010, the entire contents of which are incorporated herein by reference.

### BACKGROUND OF THE INVENTION

1. Field of the Invention

The present invention relates to a method for manufacturing a lithium manganese compound oxide serving as a positive electrode active material for a nonaqueous electrolyte secondary battery, a positive electrode active material for a nonaqueous electrolyte secondary battery, and a nonaqueous electrolyte secondary battery by using the same.

2. Description of Related Art

A nonaqueous electrolyte secondary battery provided with a positive electrode by using LiCoO₂ serving as a positive electrode active material has been known previously. However, Co is a rare and expensive resource. Therefore, in the case where LiCoO₂ is used as a positive electrode active material, the production cost of a nonaqueous electrolyte secondary battery increases. Consequently, new positive electrode active materials alternative to LiCoO₂ have been researched and developed actively.

It is desired that a manganese oxide, which is one of most inexpensive transition metals, is used as a positive electrode material. Therefore, lithium manganese oxides, e.g., LiMn₂O₄ having a spinel structure (space group Fd3m), monoclinic LiMnO₂ (space group C2/m), and orthorhombic LiMnO₂ (space group Pmnm), have been noted and research and development of them have been performed. Among them, manganese is trivalent in LiMnO₂ and a high charge-discharge capacity is obtained as compared with LiMn₂O₄ in which manganese has 3.5 valence. Therefore, LiMnO₂ may be a next-generation low-cost positive electrode material.

However, regarding a method which has been employed previously and in which a mixture of various lithium compounds and a trivalent manganese compound is subjected to a solid phase reaction at 500° C. to 900° C., only orthorhombic LiMnO₂ is obtained. Furthermore, regarding orthorhombic LiMnO₂ described above, lithium can be inserted and isolated electrochemically, but the stability in charge-discharge curve relative to charge-discharge cycles is poor because transition to a spinel phase occurs due to repetition of charge and discharge.

R. J. Gummow, D C Liles and M. M. Thackeray, Materials Research Bulletin, Volume 28, Issue 12, 1249 (1993) (Non-patent Document 1) has reported that a mixture of a manganese oxide having a lithiated spinel structure and orthorhombic LiMnO₂ is obtained by mixing γ-MnO₂, LiOH, and carbon serving as a reducing agent and effecting a reaction in argon at 600° C. However, the mixture of a manganese oxide having a lithiated spinel structure and orthorhombic LiMnO₂ synthesized by the above-described method has a problem in that the discharge capacity in the 10th cycle becomes at a low level of about 160 mAh/g.

Then, synthesis of monoclinic LiMnO₂ having a large initial discharge capacity and exhibiting excellent stability in charge-discharge cycle has been studied. Under the present circumstances, this compound is synthesized by subjecting NaMnO₂, which is synthesized through a usual solid phase reaction and which has a monoclinic structure, to ion exchange in a nonaqueous solvent containing Li ions (Japanese Published Unexamined Patent Application (Translation of PCT Application) No. 2000-503453 (Patent Document 1)).

However, this method requires two steps, i.e. production of α-NaMnO₂ and ion exchange thereof. Consequently, there are problems in that, for example, mass production is difficult and a part of Na remains in an active material after ion exchange, which have an adverse effect in a battery.

In Japanese Published Unexamined Patent Application No. 11-21128 (Patent Document 2), monoclinic LiMnO₂ is obtained by subjecting at least one type of manganese raw materials to a hydrothermal treatment in an aqueous solution containing water-soluble lithium and an alkali metal hydroxide at 130° C. to 300° C. However, this method has a problem in that the cost is higher than the cost of the solid phase method because synthesis is performed by the hydrothermal treatment.

In Japanese Published Unexamined Patent Application No. 2000-348722 (Patent Document 3), LiMn_{1-y}Al_{y}O₂ (0.06≦y<0.25) having a monoclinic structure is synthesized by the solid phase method. However, there is a problem in that the initial discharge capacity becomes at a low level of about 140 mAh/g because electrochemically inert Al is added.

### BRIEF SUMMARY OF THE INVENTION

It is an object of the present invention to provide a method for manufacturing a positive electrode active material for a nonaqueous electrolyte secondary battery, wherein a lithium manganese compound oxide, which is represented by a general formula LiₓMnO₂ (x≧1) and which has a crystal structure of a space group C2/m, can be produced by a solid phase method. A positive electrode active material for a nonaqueous electrolyte secondary battery and a nonaqueous electrolyte secondary battery provided with the same are also embodiments of the present invention.

A method for manufacturing a positive electrode active material for a nonaqueous electrolyte secondary battery according to the present invention includes the steps of mixing a lithium source and a tetravalent manganese source and reacting the lithium source and the manganese source at a temperature lower than 600° C. while tetravalent manganese is reduced, so as to produce a lithium manganese compound oxide, wherein the positive electrode active material is formed from the lithium manganese compound oxide, which is represented by a general formula LiₓMnO₂ (x≧1) and which has a crystal structure of a space group C2/m.

In a manufacturing method according to the present invention, the lithium manganese compound oxide is produced by mixing the lithium source and the tetravalent manganese source and reacting the lithium source and the manganese source at a temperature lower than 600° C. while tetravalent manganese is reduced. Consequently, it is not necessary to ion-exchange Na ions for Li ions, in contrast to the technology in the related art. And the content of Na in the active material can be reduced significantly as compared with that in the case where the production is performed with ion exchange. Furthermore, large amounts of active material can be synthesized at a low cost because synthesis can be performed by the solid phase method.

According to an embodiment of the present invention, it is preferable that the lithium source and the manganese source are reacted in the presence of a reducing agent, so as to reduce tetravalent manganese. Examples of reducing agents include reducing gases and solid carbon.

Furthermore, the reaction temperature to react the lithium source and the manganese source is preferably in the range of from 300° C. to 600° C.

A positive electrode active material for a nonaqueous electrolyte secondary battery according to an embodiment of the present invention is formed from a lithium manganese compound oxide, which is represented by a general formula LiₓMnO₂ (x≧1) and which has a crystal structure of a space group C2/m.

The positive electrode active material according to an embodiment of the present invention is formed from the above-described lithium manganese compound oxide and, therefore, has a large initial discharge capacity and exhibits excellent charge-discharge cycle characteristics.

A nonaqueous electrolyte secondary battery according to an embodiment of the present invention includes a positive electrode containing a positive electrode active material, a negative electrode containing a negative electrode active material, and a nonaqueous electrolyte, wherein the positive electrode active material is the above-described positive electrode active material according to the present invention.

Regarding the nonaqueous electrolyte secondary battery according to an embodiment of the present invention, the above-described positive electrode active material according to the present invention is used. Therefore, a large initial discharge capacity is obtained and excellent charge-discharge cycle characteristics are exhibited.

According to an embodiment of the present invention, the lithium manganese compound oxide, which is represented by a general formula LiₓMnO₂ (x≧1) and which has a crystal structure of a space group C2/m, can be produced by the solid phase method. Consequently, the step to ion-exchange Na ions for Li ions is not necessary which is in contrast to the related art. And large amounts of active material can be produced at a low cost. Moreover, the content of Na in the active material can be reduced significantly.

The positive electrode active material according to an embodiment of the present invention has a large initial discharge capacity and exhibits excellent charge-discharge cycle characteristics. Consequently, the nonaqueous electrolyte secondary battery according to an embodiment of the present invention, by using the positive electrode active material according to the present invention, has a large initial discharge capacity and exhibits excellent charge-discharge cycle characteristics.

### BRIEF DESCRIPTION OF THE SEVERAL VIEWS OF THE DRAWINGS

FIG. 1 shows an X-ray diffraction chart of a lithium manganese compound oxide obtained in an example according to the present invention.

### DETAILED DESCRIPTION OF THE INVENTION

The present invention will be described below in further detail.

<Tetravalent Manganese Source>

A tetravalent manganese source used in the present invention is not specifically limited insofar as the tetravalent manganese source is a compound of tetravalent manganese. Typical examples of tetravalent manganese sources include manganese dioxide (MnO₂). Manganese dioxide takes on various structures and manganese dioxide having any structure can be used. Furthermore, Li₂MnO₃ and the like are also tetravalent manganese compounds and can be used as raw materials. For example, a mixture of MnO₂ and Li₂MnO₃ can also be used as a raw material.

<Lithium Source>

A lithium source used in the present invention is not specifically limited insofar as the lithium source is a compound containing lithium. Examples of lithium sources include lithium hydroxide, lithium oxide, lithium carbonate, lithium nitrate, lithium oxalate, and lithium acetate.

<Mixing Ratio of Lithium Source to Tetravalent Manganese Source>

The mixing ratio Li/Mn of lithium source to tetravalent manganese source in terms of molar ratio is preferably 1 or more. In the case where the mixing ratio Li/Mn is 1 or more, a large initial discharge capacity is obtained and excellent charge-discharge cycle characteristics are exhibited. Furthermore, it is more preferable that the mixing ratio Li/Mn in terms of molar ratio is more than 1. In the case where the mixing ratio Li/Mn is specified to be more than 1, a larger initial discharge capacity is obtained.

If the Li/Mn molar ratio is less than 1, the initial discharge capacity may be reduced.

<Reducing Agent>

According to the present invention, it is preferable that tetravalent manganese is reduced by reacting the lithium source and the manganese source in the presence of a reducing agent. As for the reducing agent, a reducing gas, e.g., a hydrogen gas or a carbon gas, may be used, or solid carbon or the like may be used. The solid carbon is used preferably because the solid carbon is easily available and is inexpensive and the amount of addition can be controlled easily.

As the solid carbon, a carbon material, e.g., acetylene black or Ketjenblack, exhibiting low crystallinity and having a large specific surface area is used preferably. In the case where solid carbon exhibiting low crystallinity and having a large specific surface area is used, a reaction with the tetravalent manganese occurs easily and reduction can be performed in a shorter time.

The amount of solid carbon added as a reducing agent is preferably 0.03 or more in terms of molar ratio of carbon to manganese (C/Mn). If the C/Mn molar ratio is less than 0.03, reduction does not proceed sufficiently and monoclinic LiMnO₂ is not obtained in some cases. Consequently, a lithium manganese compound oxide having a crystal structure of a space group C2/m is not obtained in some cases.

In the case where every tetravalent manganese is reduced to trivalent manganese by carbon, the required amount of carbon is 0.25 in terms of carbon (C)/manganese (Mn) molar ratio. However, the amount of carbon used may be increased to exceed C/Mn=0.25. Excess carbon remains in the active material after synthesis. However, while being unreacted, the unreacted carbon does not adversely affect the battery characteristics. Moreover, when an electrode is produced, the remaining carbon can contribute to the electrical conductivity in the electrode.

However, if carbon remains excessively after synthesis of the active material, problems occur in that, for example, filling properties of the electrode are degraded. Therefore, the C/Mn molar ratio is preferably less than 2.5.

<Reaction Temperature>

According to the present invention, the reaction temperature in the reaction between the lithium source and the manganese source is preferred to be lower than 600° C. If the reaction temperature is 600° C. or higher, the lithium manganese compound oxide having a crystal structure of a space group Pmnm is generated easily. Therefore, it is preferable that the reaction temperature is lower than 600° C. In the case where the temperature is lower than 600° C., monoclinic oxides represented by the general formula LiₓMnO₂ (x≧1) are stable, and in the case where the temperature is 600° C. or higher, orthorhombic lithium manganese compound oxides are stable. Consequently, the lithium manganese compound oxide according to the present invention is not easily obtained at a high temperature of 600° C. or higher.

The reaction temperature is preferably 300° C. or higher. If the reaction temperature is too low, the reaction between the lithium source and the tetravalent manganese source may not be sufficient.

Manganese dioxide (MnO₂) releases oxygen in an inert gas atmosphere at 400° C. or higher to become Mn₂O₃. Therefore, it is preferable that the reaction temperature (firing temperature) and the type and the amount of reducing agent are adjusted appropriately in consideration of those described above.

According to an embodiment of the present invention, the reaction temperature is more preferably 350° C. or higher and 550° C. or lower, and further preferably 400° C. or higher and 500° C. or lower.

According to an embodiment of the present invention, the reaction time (firing time) is not specifically limited, but the reaction time is preferably within the range of 1 to 24 hours in general.

<Reaction Atmosphere>

According to an embodiment of the present invention, it is preferable that the atmosphere of the reaction between the lithium source and the manganese source in the presence of a solid reducing agent is an inert gas atmosphere, e.g., argon, or a nitrogen gas atmosphere. The lithium source and the manganese source can be reacted while tetravalent manganese is reduced by effecting the reaction in such an atmosphere.

<Nonaqueous Electrolyte Secondary Battery>

The nonaqueous electrolyte secondary battery according to an embodiment of the present invention includes a positive electrode containing a positive electrode active material, a negative electrode containing a negative electrode active material, and a nonaqueous electrolyte, wherein the positive electrode active material is the above-described positive electrode active material according to the present invention.

[Positive Electrode]

The positive electrode is not specifically limited insofar as the above-described positive electrode active material according to the present invention is included. The positive electrode may have, for example, a collector formed from electrically conductive foil, e.g., metal foil or alloy foil, and a positive electrode active material layer disposed on the surface of the collector, wherein the above-described positive electrode active material according to the present invention is contained in the positive electrode active material layer. Besides the above-described positive electrode active material according to the present invention, other materials, e.g., a binder and an electrically conductive agent, may be contained in the positive electrode active material layer.

Examples of binders added to the positive electrode active material layer include polytetrafluoroethylenes, polyvinylidene fluorides, polyethylene oxides, polyvinyl acetates, polymethacrylates, polyacrylates, polyacrylonitriles, polyvinyl alcohols, styrene-butadiene rubber, and carboxymethyl cellulose. These binders may be used alone or a plurality of types may be used in combination.

In the case where the electrical conductivity of the positive electrode active material is high, an electrically conductive agent is not necessarily added to the positive electrode active material layer. On the other hand, in the case where the electrical conductivity of the positive electrode active material is low, it is preferable that an electrically conductive agent is added to the positive electrode active material layer.

Examples of electrically conductive agents include carbon materials, e.g., carbon black, electrically conductive oxides, electrically conductive nitrides, and electrically conductive carbides.

[Negative Electrode]

According to an embodiment of the present invention, the negative electrode is not specifically limited. The negative electrode may contain, for example, lithium, silicon, carbon materials, tin, germanium, aluminum, lead, indium, gallium, a lithium alloy, a silicon alloy, or carbon materials or silicon materials occluding lithium in advance as a negative electrode active material. The negative electrode may have a negative electrode collector and a negative electrode active material layer disposed on the negative electrode collector. The negative electrode active material layer may contain a binder and an electrically conductive agent in addition to the above-described negative electrode active material, as in the case of the above-described positive electrode mix layer.

[Nonaqueous Electrolyte]

According to an embodiment of the present invention, the nonaqueous electrolyte is not specifically limited as well. Examples of solvents of the nonaqueous electrolyte include cyclic carbonic acid esters, chain carbonic acid esters, esters, cyclic ethers, chain ethers, nitriles, and amides. Examples of cyclic carbonic acid esters include ethylene carbonate, propylene carbonate, and butylene carbonate. These cyclic carbonic acid esters, in which a part of or all hydrogen groups are fluorinated, can also be used as the solvent of the nonaqueous electrolyte. Examples of cyclic carbonic acid esters, in which a part of or all hydrogen groups are fluorinated, include trifluoropropylene carbonate and fluoroethylene carbonate. Examples of chain carbonic acid esters include dimethyl carbonate, ethylmethyl carbonate, diethyl carbonate, methylpropyl carbonate, ethylpropyl carbonate, and methylisopropyl carbonate. These chain carbonic acid esters, in which a part of or all hydrogen groups are fluorinated, can also be used as the solvent of the nonaqueous electrolyte. Examples of esters include methyl acetate, ethyl acetate, propyl acetate, methyl propionate, ethyl propionate, and γ-butyrolactone. Examples of cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineole, and crown ether. Examples of chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxyethane, 1,1-diethoxyethane, triethylene glycol dimethyl ether, and tetraethylene glycol dimethyl ether. Examples of nitriles include acetonitrile. Examples of amides include dimethylformamide. A mixture of a plurality of the above-described solvents may be used as a solvent of the nonaqueous electrolyte.

Examples of lithium salts added to the nonaqueous electrolyte include LiBF₄, LiPF₆, LiCF₃SO₃, LiC₄F₉SO₃, LiN(CF₃SO₂)₂, LiN(C₂F₅SO₂)₂, LiAsF₆, lithium difluoro(oxalate)borate, and a mixture of at least two types thereof.

### EXAMPLES

The present invention will be described below in further detail. The present invention is not limited to the following examples and can be modified appropriately within the bounds of not departing from the gist thereof, so as to be executed.

### Experiment 1

### Example 1

### Preparation of Positive Electrode Active Material

Mixing of γ-MnO₂ (produced by Kishida Chemical Co., Ltd., extra pure reagent, purity 90%) and LiOH (produced by Kishida Chemical Co., Ltd., analytical grade reagent, purity 98%) was performed in such a way that the molar ratio (Li:Mn) became 1:1. The resulting mixture was mixed with solid carbon (KETJENBLACK) serving as a reducing agent in such a way that the molar ratio (Mn:C) became 4:1. Acetone was added to the mixture of γ-MnO₂, LiOH, and KFTJENBLACK. The resulting mixture was agitated and mixed by using a ball mill at a speed of 200 rpm for 1 hour.

The resulting mixture was taken out, dried, and fired in an argon (Ar) stream at 450° C.

An XRD measurement of the powder obtained through firing was performed to identify the structure of a primary component. The peak of the primary component agreed with PDF#87-1255 and, therefore, it was made clear that the powder had a structure represented by the space group C2/m. Consequently, it was specified that the resulting powder was a lithium manganese compound oxide which was represented by LiMnO₂ and which had a crystal structure of the space group C2/m.

[Preparation of Positive Electrode]

A positive electrode mix slurry was prepared by mixing 90 percent by mass of the positive electrode active material obtained as described above and 5 percent by mass of acetylene black serving as an electrically conductive agent, adding 5 percent by mass of polyacrylonitrile (PAN) serving as a binder to the resulting mixture, and adding an appropriate amount of N-methyl-2-pyrrolidone (NMP) thereto, followed by mixing.

The resulting positive electrode mix slurry was applied to an aluminum foil serving as a collector by using a doctor blade method and, after the application, drying was performed at 80° C. by using a hot plate. After the drying, rolling was performed by using a roller, so as to obtain a positive electrode.

[Preparation of Test Cell]

A test cell was prepared by using the thus prepared positive electrode as a working electrode, and using lithium metal as a counter electrode and a reference electrode. A nonaqueous electrolyte prepared by adding LiPF₆ to a mixed solvent, in which ethylene carbonate (EC) and diethyl carbonate (DEC) were mixed at a ratio of 30:70 on a volume ratio basis, in such a way that the concentration of LiPF₆ became 1 mol/l was used.

[Charge-Discharge Cycle Test]

The above-described test cell was subjected to a charge-discharge test, where charge was performed at a constant current of 40 mA/g until 4.3 V was reached, and constant voltage charge was further performed at a constant voltage of 4.3 V until the current value reached 10 mA/g. After a suspension for 10 minutes, discharge was performed at a constant current of 40 mA/g until 2.0 V was reached.

The discharge capacity in the first cycle (initial discharge capacity) was measured and the results are shown in Table 1.

Regarding Example 4 and Comparative example 1 described later, the above-described charge-discharge cycle was performed 10 times, and the discharge capacity in the 10th cycle was determined.

### Examples 2 to 7

Positive electrode active materials were prepared in the same manner as in Example 1 except that the firing temperatures, the Li/Mn molar ratios, and the C/Mn molar ratios were specified to be values shown in Table 1.

Regarding the obtained positive electrode active material, the primary component was identified in the same manner as in Example 1. A positive electrode was prepared as in Example 1 by using the obtained positive electrode active material. A test cell was prepared by using the resulting positive electrode, and the charge-discharge test was performed as in Example 1.

The results of identification of the primary components by XRD and the initial discharge capacities are shown in Table 1.

### Comparative Example 1

Mixing of Mn₂O₃ (produced by Aldrich) serving as a trivalent manganese source and LiOH serving as a lithium source was performed in such a way that the molar ratio (Li:Mn) became 1:1. Acetone was added to the resulting mixture and mixing was performed by using a ball mill at a speed of 200 rpm for 1 hour. Thereafter, the mixture was taken out, dried, and fired in an argon (Ar) stream at 650° C.

An XRD measurement of the resulting fired powder was performed to identify the structure of a primary component. The peak of the primary component agreed with PDF#35-0749 and, therefore, it was made clear that the powder had a structure represented by the space group Pmnm.

A positive electrode was prepared in the same manner as in the above-described example, a test cell was prepared by using the resulting positive electrode, and the charge-discharge test was performed. The initial discharge capacity is shown in Table 1.

### Comparative Example 2

A positive electrode active material was prepared in the same manner as in Example 1 except that the firing temperature, the Li/Mn molar ratio, and the C/Mn molar ratio were specified to be values shown in Table 1. A positive electrode was prepared by using the obtained positive electrode active material, a test cell was prepared by using the resulting positive electrode, and the charge-discharge test was performed.

The result of identification of the primary component by the XRD measurement and the initial discharge capacity are shown in Table 1.

Regarding Example 4 and Comparative example 1, the discharge capacities in the 10th cycle were determined. The measurement results are shown in Table 1.

TABLE 1

| | Firing | Li/Mn | C/Mn | Primary | Initial discharge | Discharge capacity |
|---|---|---|---|---|---|---|
| | temperature | molar ratio | molar ratio | component | capacity (mAh/g) | in 10th cycle |
| Example 1 | 450° C. | 1.00 | 0.25 | C2/m | 169.1 | |
| Example 2 | 450° C. | 1.00 | 0.125 | C2/m | 180.0 | |
| Example 3 | 450° C. | 1.00 | 0.09375 | C2/m | 179.8 | |
| Example 4 | 425° C. | 1.00 | 0.09375 | C2/m | 182.4 | 175.1 |
| Example 5 | 425° C. | 1.10 | 0.09375 | C2/m | 185.3 | |
| Example 6 | 425° C. | 1.20 | 0.09375 | C2/m | 203.0 | |
| Example 7 | 425° C. | 1.30 | 0.09375 | C2/m | 207.3 | |
| Comparative | 650° C. | 1.00 | 0 | Pmnm | 19.7 | 50.2 |
| example 1 | | | | | | |
| Comparative | 425° C. | 0.95 | 0.09375 | C2/m | 142.4 | |
| example 2 | | | | | | |

As shown in Table 1, regarding Examples 1 to 7 in which the lithium source and the tetravalent manganese source were mixed and the lithium source and the manganese source were reacted at a temperature lower than 600° C. while tetravalent manganese was reduced, according to the present invention, lithium manganese compound oxides, which had the crystal structure of a space group C2/m and which is represented by the general formula LiₓMnO₂ (x≧1), were obtained. In Examples 5 to 7, x in the general formula LiₓMnO₂ was 1.10, 1.20, and 1.30, respectively.

In Comparative example 1, a lithium manganese compound oxide having a crystal structure of the space group Pmnm was prepared. As is clear from the results shown in Table 1, in the case where such a lithium manganese compound oxide was used as a positive electrode active material, the initial discharge capacity was low significantly and the discharge capacity in the 10th cycle was also low. Therefore, it is clear that a high discharge capacity and good recycle characteristics are obtained by using the lithium manganese compound oxide, which is obtained by the manufacturing method according to the present invention, which is represented by the general formula LiₓMnO₂ (x≦1), and which has the crystal structure of the space group C2/m, as the positive electrode active material.

Regarding Comparative example 2, the Li/Mn molar ratio was specified to be 0.95, and it is clear that the initial discharge capacity was reduced when x in the general formula LiₓMnO₂ was less than 1.

As is clear from comparisons between Examples 5 to 7 and Examples 1 to 4, a still higher discharge capacity was obtained by using the lithium manganese compound oxide represented by the general formula LiₓMnO₂ (x>1) as a positive electrode active material.

### Experiment 2

### Examples 8 to 13

Positive electrode active materials were prepared in the same manner as in Example 1 except that the firing temperatures, the Li/Mn molar ratios, and the C/Mn molar ratios were specified to be values shown in Table 2.

### Comparative Examples 3 to 6

Positive electrode active materials were prepared in the same manner as in Example 1 except that the firing temperatures and the Li/Mn molar ratios were specified to be values shown in Table 2 and the C/Mn molar ratios were specified to be 0. That is, firing was performed without adding a reducing agent.

### Comparative Examples 7 and 8

Positive electrode active materials were prepared in the same manner as in Example 1 except that the firing temperatures, the Li/Mn molar ratios, and the C/Mn molar ratios were specified to be values shown in Table 2.

The results of identification of the primary components by the XRD measurement of the positive electrode active materials prepared in Examples 8 to 13 and Comparative examples 3 to 8 are shown in Table 2.

TABLE 2

| | Firing | Li/Mn | C/Mn | Primary |
|---|---|---|---|---|
| | temperature | molar ratio | molar ratio | component |
| Example 8 | 400° C. | 1.00 | 0.25 | C2/m |
| Example 9 | 350° C. | 1.00 | 0.25 | C2/m |
| Example 10 | 400° C. | 1.00 | 0.125 | C2/m |
| Example 11 | 550° C. | 1.00 | 0.03 | C2/m |
| Example 12 | 550° C. | 1.00 | 0.0625 | C2/m |
| Example 13 | 500° C. | 1.00 | 0.0625 | C2/m |
| Comparative | 550° C. | 1.00 | 0 | reaction did not |
| example 3 | | | | proceed sufficiently |
| | | | | Li₂MnO₃ + Mn₃O₄ |
| Comparative | 650° C. | 1.00 | 0 | Pmnm |
| example 4 | | | | |
| Comparative | 750° C. | 1.00 | 0 | Pmnm |
| example 5 | | | | |
| Comparative | 900° C. | 1.00 | 0 | Pmnm |
| example 6 | | | | |
| Comparative | 650° C. | 1.00 | 0.125 | Pmnm |
| example 7 | | | | |
| Comparative | 650° C. | 1.00 | 0.25 | reaction proceeded |
| example 8 | | | | excessively |
| | | | | MnO + Li₂CO₃ |

As is clear from the results of Examples 8 to 13 shown in Table 2 and the results of examples 1 to 7 shown in Table 1, lithium manganese compound oxides having a crystal structure of the space group C2/m were obtained at firing temperatures within the range of 350° C. to 550° C. Furthermore, lithium manganese compound oxides having a crystal structure of the space group C2/m were obtained at C/Mn molar ratios within the range of 0.0625 to 0.25.

As is clear from the result shown in Comparative example 3, in the case where firing was performed at a firing temperature of 550° C. with no reducing agent, the reaction did not proceed sufficiently. It was made clear that in the case where firing was performed at firing temperatures within the range of 650° C. to 900° C. with no reducing agent, lithium manganese compound oxides having a crystal structure of the space group Pmnm were obtained.

As is clear from Comparative examples 7 and 8, even in the case where firing was performed in the presence of a reducing agent, when the firing temperature was 600° C. or higher, lithium manganese compound oxides having a crystal structure of the space group Pmnm were obtained or the reaction proceeded excessively.

[X-ray Diffraction Chart]

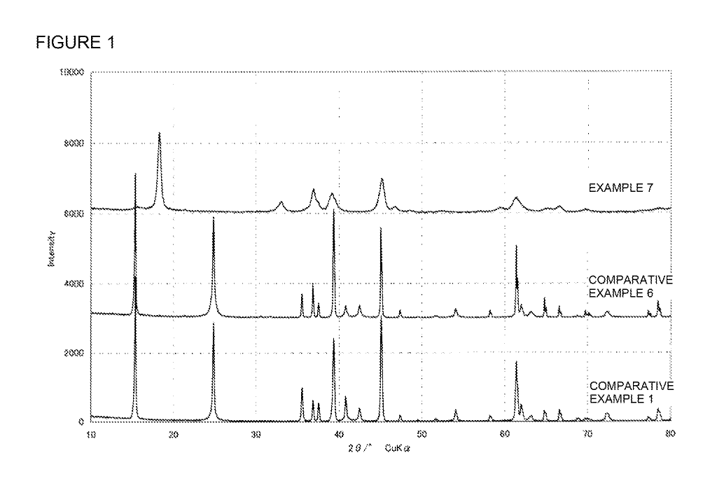

FIG. 1 shows X-ray diffraction charts in Example 7, Comparative example 1, and Comparative example 6. As shown in FIG. 1, the primary component of the positive electrode active material in Example 7 had a crystal structure of the space group C2/m. The primary components of the positive electrode active materials in Comparative example 1 and Comparative example 6 had a crystal structure of the space group Pmnm.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A method for manufacturing a positive electrode active material for a nonaqueous electrolyte secondary battery, the method comprising:
mixing a lithium source and a tetravalent manganese source;
reacting the lithium source and the manganese source at a temperature lower than 600° C. while tetravalent manganese is reduced, so as to produce a lithium manganese compound oxide; and
forming the positive electrode active material from the lithium manganese compound oxide,
wherein the lithium manganese compound oxide is represented by a general formula LiₓMnO₂ (x≧1) and the lithium manganese compound oxide has a crystal structure of a space group C2/m.

2. The method for manufacturing a positive electrode active material for a nonaqueous electrolyte secondary battery according to claim 1,
wherein the lithium source and the manganese source are reacted in the presence of a reducing agent, so as to reduce tetravalent manganese.

3. The method for manufacturing a positive electrode active material for a nonaqueous electrolyte secondary battery according to claim 2,
wherein the reducing agent is a reducing gas or a solid carbon.

4. The method for manufacturing a positive electrode active material for a nonaqueous electrolyte secondary battery according to claim 1,
wherein the reaction temperature is in the range of from 300° C. to 600° C.

5. The method for manufacturing a positive electrode active material for a nonaqueous electrolyte secondary battery according to claim 2,
wherein the reaction temperature is in the range of from 300° C. to 600° C.

6. The method for manufacturing a positive electrode active material for a nonaqueous electrolyte secondary battery according to claim 3,
wherein the reaction temperature is in the range of from 300° C. to 600° C.

7. The method for manufacturing a positive electrode active material for a nonaqueous electrolyte secondary battery according to claim 1,
wherein the lithium manganese compound oxide is represented by a general formula LiₓMnO₂ (x>1).

8. The method for manufacturing a positive electrode active material for a nonaqueous electrolyte secondary battery according to claim 2,
wherein the lithium manganese compound oxide is represented by a general formula LiₓMnO₂ (x>1).

9. The method for manufacturing a positive electrode active material for a nonaqueous electrolyte secondary battery according to claim 3,
wherein the lithium manganese compound oxide is represented by a general formula LiₓMnO₂ (x>1).

10. The method for manufacturing a positive electrode active material for a nonaqueous electrolyte secondary battery according to claim 4,
wherein the lithium manganese compound oxide is represented by a general formula LiₓMnO₂ (x>1).

11. The method for manufacturing a positive electrode active material for a nonaqueous electrolyte secondary battery according to claim 5,
wherein the lithium manganese compound oxide is represented by a general formula LiₓMnO₂ (x>1).

12. The method for manufacturing a positive electrode active material for a nonaqueous electrolyte secondary battery according to claim 6,
wherein the lithium manganese compound oxide is represented by a general formula LiₓMnO₂ (x>1).

13. A positive electrode active material for a nonaqueous electrolyte secondary battery, comprising a lithium manganese compound oxide, which is represented by a general formula LiₓMnO₂ (x≧1) and which has a crystal structure of a space group C2/m.

14. A nonaqueous electrolyte secondary battery comprising:
a positive electrode containing a positive electrode active material;
a negative electrode containing a negative electrode active material; and
a nonaqueous electrolyte,
wherein the positive electrode active material is the positive electrode active material according to claim 5.

15. A positive electrode active material for a nonaqueous electrolyte secondary battery according to claim 13,
wherein the lithium manganese compound oxide is represented by a general formula LiₓMnO₂ (x>1).

16. A nonaqueous electrolyte secondary battery comprising:
a positive electrode containing a positive electrode active material;
a negative electrode containing a negative electrode active material; and
a nonaqueous electrolyte,
wherein the positive electrode active material is the positive electrode active material according to claim 15.
